(19) United States
(12) Patent Application Publication
(10) Pub. No.: US 2025/0316075 A1
(43) Pub. Date: Oct. 9, 2025

(54) Machine Learning for Computation of Visual Attention Center

(71) Applicant: Google LLC, Mountain View, CA (US)

(72) Inventors: Junfeng He, Fremont, CA (US); Moritz Firsching, Zurich (CH); Jyrki Antero Alakuijala, Wollerau, Canton of Schwyz (CH); Kai Jochen Kohlhoff, Mountain View, CA (US)

(21) Appl. No.: 18/865,648

(22) PCT Filed: May 13, 2022
(86) PCT No.: PCT/US2022/029168

§ 371 Date: Nov. 13, 2024

(51) Int. Cl. G06V 10/88; G06T 9/00; G06V 10/62; G06V 10/82

(52) U.S. Cl. CPC G06V 10/92; G06T 9/00; G06V 10/62; G06V 10/82

(57) ABSTRACT

Provided are systems and methods for training and using a machine-learned model to predict a visual attention center for an image. As one example, the predicted visual attention center for the image can be used in ordering image regions for encoding, decoding, transmitting, and/or loading in a progressive image loading format.

### FIELD

The present disclosure relates generally to image processing. More particularly, the present disclosure relates to systems and methods for training and using a machine-learned model to predict a visual attention center for an image (e.g., for use in ordering image regions for encoding, decoding, transmitting, and/or loading in a progressive image loading format).

### BACKGROUND

There are a number of metrics or measures of human visual analysis relative to imagery (e.g., a digital image). For example, in computer science, a saliency map or “heatmap” can refer to a representation or illustration (e.g., using brightness or other scalar values) of how important a given region (e.g., pixel) of an image is to the human visual perception or understanding of the image.

For example, saliency maps can be generated by evaluating, for each image region, the amount of time on which a human focuses their visual attention (e.g., gaze) on the image region over a particular period of time. Thus, saliency maps may assist in identifying the region(s) of an image that a human views for the longest amount of time.

However, saliency maps typically fail to capture or communicate temporal aspects of the attention information such as on which region of the image the human focuses visual attention first, rather than the longest. Further, understanding (e.g., from a saliency map) on which region of the image the human focuses visual attention for the longest period does not equate with or identify the location of the center of visual attention for the image as a whole. Similarly, identifying only the initial eye gaze point for an image also fails to account for image-level attention dynamics.

### SUMMARY

Aspects and advantages of embodiments of the present disclosure will be set forth in part in the following description, or can be learned from the description, or can be learned through practice of the embodiments.

One example aspect of the present disclosure is directed to a computer system for prediction of visual attention centers, the computer system comprising: one or more processors; a machine-learned visual attention center prediction model configured to receive and process an input image to predict a visual attention center for the input image; and one or more non-transitory computer-readable media that collectively store instructions that, when executed by the one or more processors, cause the computer system to perform operations. The operations comprise: obtaining the input image; processing the input image with the machine-learned visual attention center prediction model to obtain the visual attention center for the input image; and providing the visual attention center for the input image as an output.

In some implementations, the input image comprises a plurality of pixels; and the machine-learned visual attention center prediction model is configured to predict a single group of one or more pixels as the visual attention center for the input image.

In some implementations, the input image comprises a plurality of pixels; and the machine-learned visual attention center prediction model is configured to predict a single pixel as the visual attention center for the input image.

In some implementations, the visual attention center predicted for the input image by the machine-learned visual attention center prediction model comprises a portion of the input image that is predicted to be at a center of human visual attention afforded to the input image over a period of viewing time.

In some implementations, providing the visual attention center for the input image as the output comprises: ordering a plurality of subportions of the input image into an encoding or decoding order, wherein the encoding or decoding order is based at least in part on the visual attention center for the input image; and encoding or decoding the input image according to a progressive image loading format and according to the encoding or decoding order.

In some implementations, the progressive image loading format comprises JPEG XL.

In some implementations, the machine-learned visual attention center prediction model has been trained on a set of training data; the training data comprises a plurality of training examples; and each training example comprises a training image and a label that indicates a labelled visual attention center for the training image.

In some implementations, the labelled visual attention center for the training image for each training image has been generated by: obtaining a plurality of attention points for the training image, the plurality of attention points indicating respective locations of human visual attention on the training image; filtering the plurality of attention points to determine a filtered set of attention points; and determining the labelled visual attention center based on the filtered set of attention points.

In some implementations, filtering the plurality of attention points to determine the filtered set of attention points comprises one or both of: performing temporal filtering to filter out any of the plurality of attention points that correspond to respective locations of human visual attention that occur after a threshold period of viewing time; and performing spatial filtering to filter out any of the plurality of attention points that exist in a region of the training image having a attention point density below a threshold level of density.

Another example aspect is directed to a computer-implemented method for training a visual attention center prediction model. The method comprises: obtaining, by a computing system comprising one or more computing devices, a set of training data, wherein the training data comprises a plurality of training examples, and wherein each training example comprises a training image and a label that indicates a labelled visual attention center for the training image; accessing, by the computing system, the visual attention center prediction model, wherein the visual attention center prediction model is configured to receive and process an input image to predict a visual attention center for the input image; and for each of the plurality of training examples: processing, by the computing system, the training image with the visual attention center prediction model to obtain a predicted visual attention center for the training image; evaluating, by the computing system, a loss function that compares the predicted visual attention center for the training image to the labelled visual attention center for the training image provided by the label; and modifying, by the computing system, one or more parameters of the visual attention center prediction model based on the loss function.

In some implementations, obtaining, by the computing system, the set of training data, comprises generating, by the computing system, the respective label for each training image; and for each training image, generating, by the computing system, the respective label comprises: obtaining, by the computing system, a plurality of attention points for the training image, the plurality of attention points indicating respective locations of human visual attention on the training image; determining, by the computing system, the labelled visual attention center based on the plurality of attention points.

In some implementations, determining, by the computing system, the labelled visual attention center based on the plurality of attention points comprises: filtering, by the computing system, the plurality of attention points to determine a filtered set of attention points; and determining, by the computing system, the labelled visual attention center based on the filtered set of attention points.

In some implementations, filtering the plurality of attention points to determine the filtered set of attention points comprises: performing, by the computing system, temporal filtering to filter out any of the plurality of attention points that correspond to respective locations of human visual attention that occur after a threshold period of viewing time.

In some implementations, filtering the plurality of attention points to determine the filtered set of attention points comprises performing, by the computing system, spatial filtering to filter out any of the plurality of attention points that exist in a region of the training image having a attention point density below a threshold level of density.

In some implementations, determining, by the computing system, the labelled visual attention center based on the filtered set of attention points comprises: determining a center of the filtered set of attention points; and setting the labelled visual attention center equal to the center of the filtered set of attention points.

In some implementations, each training image comprises a plurality of pixels; and the visual attention center prediction model is configured to predict a single group of one or more pixels as the predicted visual attention center for the training image.

In some implementations, each training image comprises a plurality of pixels; and the visual attention center prediction model is configured to predict a single pixel as the predicted visual attention center for the training image.

In some implementations, the predicted visual attention center predicted for each training image by the visual attention center prediction model comprises a portion of the training image that is predicted to be at a center of human visual attention afforded to the training image over a period of viewing time.

Another example aspect is directed to one or more non-transitory computer-readable media that collectively store instructions, that when executed by one or more processors, cause the one or more processors to perform operations to encode an input image, the operations comprising: obtaining the input image; processing the input image with a machine-learned visual attention center prediction model to obtain a visual attention center predicted for the input image by the machine-learned visual attention center prediction model; ordering a plurality of subportions of the input image into an encoding or decoding order, wherein the encoding or decoding order is based at least in part on the visual attention center predicted for the input image by the machine-learned visual attention center prediction model; and encoding or decoding the input image according to a progressive image loading format and the encoding or decoding order.

In some implementations, the progressive image loading format comprises JPEG XL

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1A depicts a block diagram of operation of an example visual attention center prediction model according to example embodiments of the present disclosure.

FIG. 1B depicts a block diagram of an example architecture of an example visual attention center prediction model according to example embodiments of the present disclosure.

FIG. 2A depicts a block diagram of an example approach to train an example visual attention center prediction model according to example embodiments of the present disclosure.

FIG. 2B depicts a block diagram of an example approach to generate training data according to example embodiments of the present disclosure.

FIG. 3 depicts a graphical diagram of application of a predicted visual attention center in a progressive image loading algorithm according to example embodiments of the present disclosure.

FIG. 4A depicts a block diagram of an example computing system according to example embodiments of the present disclosure.

FIG. 4B depicts a block diagram of an example computing device according to example embodiments of the present disclosure.

FIG. 4C depicts a block diagram of an example computing device according to example embodiments of the present disclosure.

Reference numerals that are repeated across plural figures are intended to identify the same features in various implementations.

### DETAILED DESCRIPTION

### Overview

The visual attention center of an image refers to the center of human attention when a viewer initially views the image. It may therefore not correspond to exactly where the viewer looks first and/or the longest, but may instead represent a location that corresponds to a center of multiple points of attention over a limited period of viewing time, thereby capturing the viewer's actual intention. The visual attention center may for example comprise a pixel having x and y coordinates which are, respectively, the mean of the x and y coordinates of the pixels of a set of attention points. The set of attention points may correspond to locations to which a human viewer has given visual attention within a limited time period after the image is presented to the viewer. Methods of measuring such attention points are described in more detail below.

Generally, the present disclosure is directed to systems and methods for training and using a machine-learned model to predict a visual attention center for an image. As one example, the predicted visual attention center for the image can be used in ordering image regions for encoding, decoding, transmitting, and/or loading in a progressive image loading format.

More particularly, one aspect of the present disclosure relates to the use of a machine-learned visual attention center prediction model. The machine-learned visual attention center prediction model can be configured to receive and process an input image to predict a visual attention center for the input image. Thus, a computing system can obtain an input image and process the input image with the machine-learned visual attention center prediction model to obtain the visual attention center for the input image.

In some implementations, the input image can include a plurality of pixels and the machine-learned visual attention center prediction model can be configured to predict a single group of one or more pixels as the visual attention center for the input image. For example, the machine-learned visual attention center prediction model can be configured to predict a single pixel as the visual attention center for the input image.

In particular, the visual attention center predicted for the input image by the machine-learned visual attention center prediction model can be a portion of the input image that is predicted to be at a center of human visual attention afforded to the input image over a period of viewing time (e.g., an initial period of viewing time). Thus, in some instances, the predicted visual attention center may not correspond to exactly where the human looks first and/or the longest, but instead may represent a location that corresponds to a center of multiple points of attention over the period of viewing time.

Another aspect of the present disclosure relates to a technique for training the visual attention center prediction model to predict the visual attention center for the input image. The model can be trained on a set of training data (e.g., using supervised learning techniques). In some implementations, the set of training data can include a plurality of training examples. For example, each training example can include a training image and a label that indicates a labelled visual attention center for the training image. The labelled visual attention center can also be referred to as a “ground truth” visual attention center.

In some implementations, the training examples can be generated by providing (e.g., displaying) a training image to a human labeler/viewer and, with the consent of human labeler/viewer, collecting a number of attention points within the training image from or with respect to the human labeler/viewer. The attention points can correspond to respective locations of human visual attention on the training image.

As one example, the attention points for a training image can be collected by analyzing locations of eye gaze of the human labeler/viewer on the training image when the human labeler/viewer is shown the training image. For example, various eye gaze detection/localization techniques (e.g., machine learning based techniques) are known in the art and can be used to identify attention points that correspond to locations of eye gaze when the human labeler/viewer is shown the training image.

As another example, the attention points for a training image can be collected by assessing where the human labeler/viewer makes input actions (e.g., mouse clicks, taps, touches, zooms, etc.) on the training image. As yet another example, the attention points for a training image can be collected by displaying a blurred version of the image to the human labeler/viewer and asking the human labeler/viewer to identify points at which the human labeler/viewer wishes to receive additional resolution or visual information (e.g., which portions the human labeler/viewer wishes to have deblurred).

In some implementations, the labelled visual attention center for each training image can be generated or determined based on the attention points for the image. As an example, in some implementations, for each image, the plurality of attention points can be filtered to determine a filtered set of attention points and the labelled visual attention center can be determined based on the filtered set of attention points. As examples, the filtering can include temporal filtering and/or spatial filtering.

Thus, in some implementations, filtering the attention points can include performing temporal filtering. Temporal filtering can include filtering out (e.g., removing) any of the plurality of attention points that correspond to respective locations of human visual attention that occur after a threshold period of viewing time. As such, the remaining attention points will better represent the initial center of attention when a human initially views the image.

Additionally or alternatively, in some implementations, filtering the attention points can include performing spatial filtering. Spatial filtering can include filtering out (e.g., removing) any of the plurality of attention points that exist in a region of the training image having a attention point density below a threshold level of density.

As one example, to perform spatial filtering, each attention point can be represented using a weight distribution (e.g., a two-dimensional Gaussian distribution centered at the attention point). That is, a positive weight value can be assigned to locations around the attention point, where the weight value at each location is inversely proportional to a distance from the location to the attention point. A weight map can be generated for the image. The respective weight at each location in the weight map can be representative of a density of attention points around the location. For example, for locations where multiple attention points are nearby, the weight distributions from such multiple points will overlap and sum to a larger weight value for such locations. In this context, spatial filtering can include removing attention points that are at locations that have a corresponding weight value in the weight map that is less than a threshold value.

After the attention points have been optionally filtered as described above, the labelled visual attention center can be determined for the training image. For example, an average location can be determined from the attention points (e.g., the attention points remaining after filtering) and can be selected as the labelled visual attention center for the training image. The training image can be annotated or labelled with the labelled visual attention center.

The visual attention center prediction model can be trained using the training data that includes the training images respectively labelled with their labelled visual attention centers. For example, a training system can input the training image into the visual attention center prediction model. In response, the visual attention center prediction model can output a predicted visual attention center. The training system can evaluate a loss function that compares the predicted visual attention center for the training image to the labelled visual attention center for the training image. For example, the loss function can evaluate a distance (e.g., Lp distance such as L1 distance or L2 distance) between the predicted visual attention center and the labelled visual attention center. The training system can modify one or more parameters of the visual attention center prediction model based on the loss function (e.g., via backpropagation of the loss function).

One example use or application of the visual attention center described herein is as an input to a progressive image loading algorithm. More particularly, a common goal for image transfer algorithms is to reduce the amount of time required for “loading” the image. Loading the image can include receiving the image data (e.g., formatted as bytes), potentially decoding the image data if it is encoded, and rendering the image data for display. Two techniques in particular are often used to make images load more quickly: One is showing an approximation of the image before all bytes of the image are transmitted/received, often known as “progressive image loading.” Another is making the byte size of the image smaller by using strong image compression.

Some image formats are implemented in a way that does not allow any kind of progressive image loading; all the bytes of the image have to be received and/or decoded before rendering can begin. The next, most simple type of image loading is sometimes called “sequential image loading.” For these images, the data is organized in a way that pixels are received and/or decoded in a particular order, typically in rows and from top to bottom. Sequential image loading can result in some portions of the image (e.g., the top-most rows) being shown while other portion of the image (e.g., the lower-most rows) being remaining devoid of that actual image content. Thus, these approaches fail to provide a visual experience that accommodates human perception of imagery.

In contrast, by using the predicted visual attention center for an image as an input to a progressive image loading algorithm, the progressive loading can be performed in a manner in which the portion of the image that includes the predicted visual attention center is loaded first (e.g., potentially loaded sequentially at multiple increasing resolutions). This can result in the appearance or experience, from the perspective of the viewer, that the image has been loaded more quickly. For example, the visual attention center will include the portion of the image that the user is most likely to initially focus their visual attention. By first loading the portion of the image that the user will initially focus their visual attention, the user can focus their visual attention on this portion while the remainder of the image is loaded. By the time the user has shifted their focus away from the visual attention center, the remainder of the image can have been loaded.

One example progressive image loading algorithm is the JPEG XL algorithm. JPEG XL makes it possible to send the data necessary to first display all details of the portion of the image that contains the visual attention center, followed by other parts of the image away from the visual attention center.

In general, progressive JPEG XL works in the following way: There is always an 8×8 downsampled image available (similar to a DC-only scan in a progressive JPEG). The decoder can display that with a nice upsampling, which gives the impression of a smoothed version of the image.

In addition, the image is divided into square groups (typically of size 256×256) and it is possible to provide an order of these groups during encoding. In particular, example implementations of the present disclosure can order the groups based on the location of the predicted visual attention center.

For example, while the JPEG XL format allows for a very flexible order of the groups, example implementations of the present disclosure can choose as a starting group the group that includes the predicted visual attention center. The encoding system can then grow concentric squares around that starting group. To make successive updates even less noticeable, some implementations can smooth the boundary between groups for which all the data has arrived and those that still contain an incomplete approximation. JPEG XL is provided as one example of a progressive image loading format. Other formats can be used additionally or alternatively.

Other example applications or uses for the predicted visual attention center can include automatic image editing. For example, the predicted visual attention center can be used to perform automatic image cropping (e.g., a cropping algorithm can use the predicted visual attention center as the center of the cropping or may more generally be constrained to include the predicted visual attention center within the proposed crop). As another example, the predicted visual attention center can be used as a point for starting an image animation presentation such as, for example, an iris-style wipe in which a wipe grows outward from or shrinks inward toward a point in an image (e.g., the predicted visual attention center).

As another example, the predicted visual attention center can be used to facilitate image compression. For example, a number of image compression algorithms can be seeded with a certain location and/or information (e.g., color information) that is to be retained by the compression algorithm. By providing the predicted visual attention center as an input to an image compression algorithm, the image can be compressed while preserving the viewing quality for a human viewer.

The systems and methods of the present disclosure provide a number of technical effects and benefits. As one example, as compared to saliency-based approaches, the systems described herein which predict a single visual attention center can provide a simplified and more computationally-efficient approach to analyzing visual attention on an image. Specifically, past approaches may have generated a saliency map over an entire image. This requires generating a saliency value for each pixel in the image. In contrast, the systems described herein enable prediction of a single attention center. Computer storage of the single attention center requires less memory space relative to a saliency map. Likewise, while it hypothetically may be possible to summarize a saliency map (e.g., by identifying a pixel having a maximum saliency value), such a hypothetical approach would require further processing (e.g., using a separate software program or code set). On the other hand, the proposed model-based approach can directly predict a single visual attention center, thereby reducing the storage size and latency associated with identification of the visual attention center. In addition, as discussed in the Background section, saliency-based approaches do not capture temporal aspects. Nor do such saliency-based approaches (e.g., identifying a point of maximum saliency) account for image-level dynamics such as multiple objects in an image which each may command some level of visual attention. In contrast, the proposed approach can account for image-level dynamics such as multiple objects.

With reference now to the Figures, example embodiments of the present disclosure will be discussed in further detail.

### Example Model Inference and Architecture

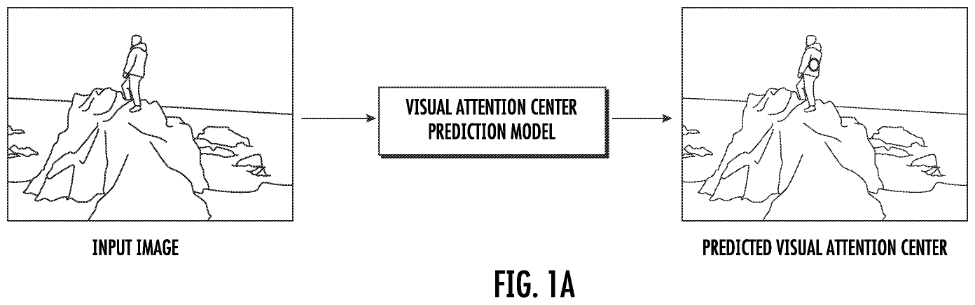

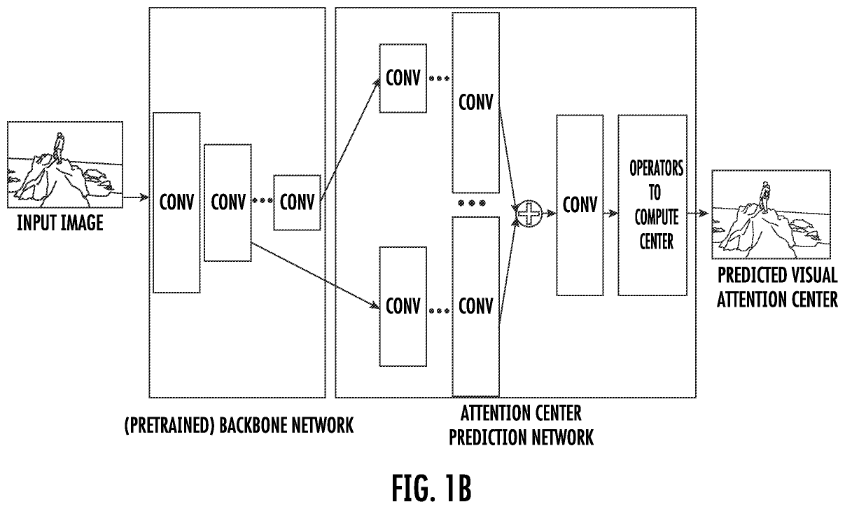

FIG. 1A depicts a block diagram of operation of an example visual attention center prediction model according to example embodiments of the present disclosure. Specifically, as illustrated in FIG. 1A, the machine-learned visual attention center prediction model can be configured to receive and process an input image to predict a visual attention center for the input image. Thus, a computing system can obtain an input image and process the input image with the machine-learned visual attention center prediction model to obtain the visual attention center for the input image.

In some implementations, the input image can include a plurality of pixels and the machine-learned visual attention center prediction model can be configured to predict a single group of one or more pixels as the visual attention center for the input image. For example, the machine-learned visual attention center prediction model can be configured to predict a single pixel as the visual attention center for the input image.

In particular, the visual attention center predicted for the input image by the machine-learned visual attention center prediction model can be a portion of the input image that is predicted to be at a center of human visual attention afforded to the input image over a period of viewing time (e.g., an initial period of viewing time). Thus, in some instances, the predicted visual attention center may not correspond to exactly where the human looks first and/or the longest, but instead may represent a location that corresponds to a center of multiple points attention over the period of viewing time.

FIG. 1B depicts a block diagram of an example architecture of an example visual attention center prediction model according to example embodiments of the present disclosure. Specifically, as illustrated in FIG. 1B, in some implementations, as an example, the visual attention center prediction model can include a backbone network (e.g., which can be pre-trained) and an attention center prediction network. As an example, the backbone network can be a pre-trained convolutional neural network such as VGGNet, ResNet, Inception, AlexNet, MobileNet, and/or the like. The backbone can be trained, for example, on the ImageNet dataset. The attention center prediction network, which may also comprise a convolutional neural network, can be appended to the backbone network and can be fine-tuned (e.g., on task-specific training data as described below). In some implementations, as illustrated in FIG. 1B, the backbone network and the attention center prediction network can be connected at multiple different scales or resolutions. This can assist in accurately processing imagery that has objects or other image content at different scales or sizes. In particular, the attention center prediction network may have a plurality of input connections with the backbone network, each input of the attention center prediction network being directly connected to the output of a different layer of the backbone network. In particular, the output of at least one intermediate layer of the backbone network may be directly connected to an input of the attention center prediction network. Directly connecting different layers of the backbone network to the attention center prediction network allows the attention center prediction network to take into account different inputs at different hierarchical levels of the backbone network. This architectural configuration is motivated by the intuition that there are a number of different factors which affect human attention, e.g. low level features such as brightness, as well as higher level features such as structure. As shown in FIG. 1B, outputs derived from the separate input connections with the backbone network are combined within the attention center prediction network and processed using one or more final convolutional layers. As will be appreciated by those skilled in the art, appropriate operators may then be used to process the output of the last convolutional layer in order to provide a suitable form of final output for representing the predicted visual attention center. As examples, the operations can be or include a fully-connected layer, fixed (i.e. not learned) operations which transform the feature map output of the last CNN layer into an (x,y) vector, a logistic regression operator, and/or other operators.

### Example Model Training

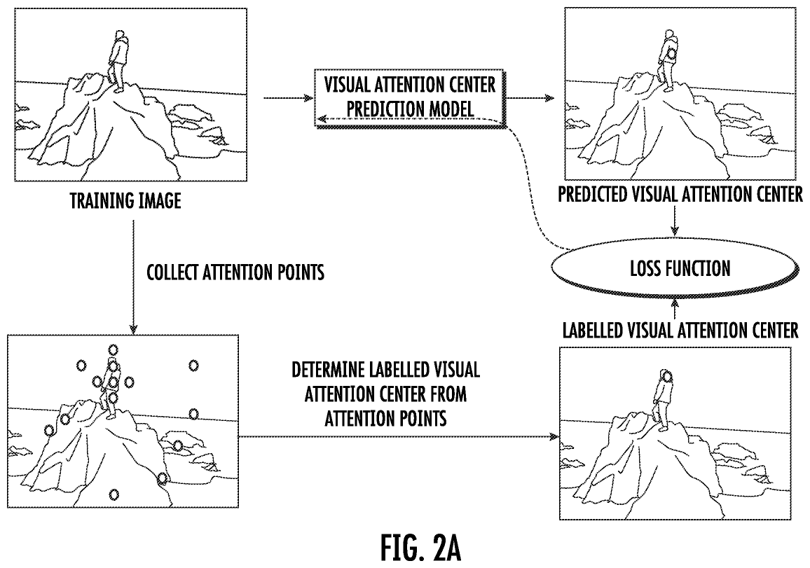

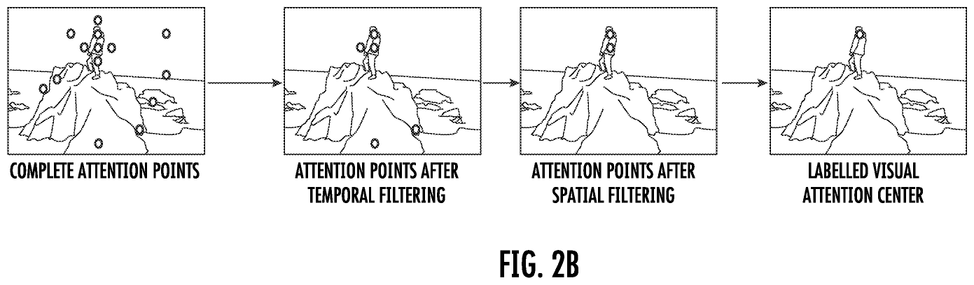

FIG. 2A depicts a block diagram of an example approach to train an example visual attention center prediction model according to example embodiments of the present disclosure. Specifically, as illustrated in FIG. 2A, the visual attention center prediction model can be trained on a set of training data (e.g., using supervised learning techniques). In some implementations, the set of training data can include a plurality of training examples. For example, each training example can include a training image and a label that indicates a labelled visual attention center for the training image. The labelled visual attention center can also be referred to as a “ground truth” visual attention center.

For example, as shown in FIG. 1A, a number of attention points can be collected for a training image. The labelled visual attention center for the training image can be determined from the attention points collected for the training image.

Thus, in some implementations, the training examples can be generated by providing (e.g., displaying) a training image to a human labeler/viewer and, with the consent of human labeler/viewer, collecting a number of attention points within the training image from or with respect to the human labeler/viewer. The attention points can correspond to respective locations of human visual attention on the training image.

As one example, the attention points for a training image can be collected by analyzing locations of eye gaze of the human labeler/viewer on the training image when the human labeler/viewer is shown the training image. For example, various eye gaze detection/localization techniques (e.g., machine learning based techniques) are known in the art and can be used to identify attention points that correspond to locations of eye gaze when the human labeler/viewer is shown the training image.

As another example, the attention points for a training image can be collected by assessing where the human labeler/viewer makes input actions (e.g., mouse clicks, taps, touches, zooms, etc.) on the training image. As yet another example, the attention points for a training image can be collected by displaying a blurred version of the image to the human labeler/viewer and asking the human labeler/viewer to identify points at which the human labeler/viewer wishes to receive additional resolution or visual information (e.g., which portions the human labeler/viewer wishes to have deblurred).

In some implementations, the labelled visual attention center for each training image can be generated or determined based on the attention points for the image. As an example, in some implementations, for each image, the plurality of attention points can be filtered to determine a filtered set of attention points and the labelled visual attention center can be determined based on the filtered set of attention points. As examples, the filtering can include temporal filtering and/or spatial filtering. Referring now to FIG. 2B, FIG. 2B shows an example process to filter the attention points and generate the labelled visual attention center.

In some implementations, filtering the attention points can include performing temporal filtering. Temporal filtering can include filtering out (e.g., removing) any of the plurality of attention points that correspond to respective locations of human visual attention that occur after a threshold period of viewing time. As such, the remaining attention points will better represent the initial center of attention when a human initially views the image.

Additionally or alternatively, in some implementations, filtering the attention points can include performing spatial filtering. Spatial filtering can include filtering out (e.g., removing) any of the plurality of attention points that exist in a region of the training image having a attention point density below a threshold level of density.

As one example, to perform spatial filtering, each attention point can be represented using a weight distribution (e.g., a two-dimensional Gaussian distribution centered at the attention point). That is, a positive weight value can be assigned to locations around the attention point, where the weight value at each location is inversely proportional to a distance from the location to the attention point. A weight map can be generated for the image. The respective weight at each location in the weight map can be representative of a density of attention points around the location. For example, for locations where multiple attention points are nearby, the weight distributions from such multiple points will overlap and sum to a larger weight value for such locations. In this context, spatial filtering can include removing attention points that are at locations that have a corresponding weight value in the weight map that is less than a threshold value.

After the attention points have been optionally filtered as described above, the labelled visual attention center can be determined for the training image. For example, an average location can be determined from the attention points (e.g., the attention points remaining after filtering) and can be selected as the labelled visual attention center for the training image. The training image can be annotated or labelled with the labelled visual attention center. Although determination of a visual attention has been described above in connection with a training image, it will be understood that a visual attention center for any image may be determined using the same techniques.

Referring back now to FIG. 2A, the visual attention center prediction model can be trained using the training data that includes the training images respectively labelled with their labelled visual attention centers. For example, a training system can input the training image into the visual attention center prediction model. In response, the visual attention center prediction model can output a predicted visual attention center. The training system can evaluate a loss function that compares the predicted visual attention center for the training image to the labelled visual attention center for the training image. For example, the loss function can evaluate a distance (e.g., Lp distance such as L1 distance or L2 distance) between the predicted visual attention center and the labelled visual attention center. The training system can modify one or more parameters of the visual attention center prediction model based on the loss function (e.g., via backpropagation of the loss function).

### Example Model Application to Progressive Image Loading

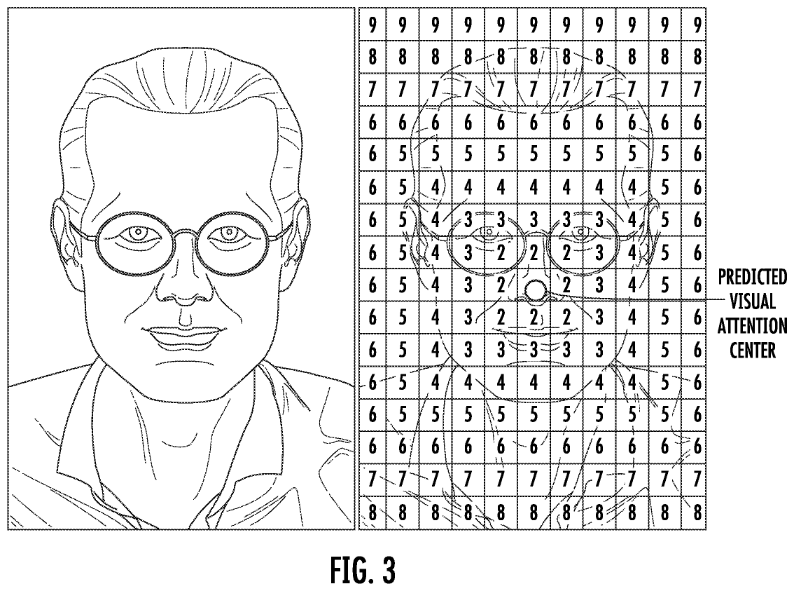

FIG. 3 depicts a graphical diagram of application of a predicted visual attention center in a progressive image loading algorithm according to example embodiments of the present disclosure. For example, on the left hand side of FIG. 3 is an image to be compressed, encoded, transmitted, loaded, etc. On the right hand side of FIG. 3, the image has been partitioned into a number of groups of pixels. Each of the groups has been assigned a position within an ordering. The image can be compressed, encoded, transmitted, loaded, etc. according to the ordering.

As an example, one example progressive image loading algorithm is the JPEG XL algorithm. JPEG XL makes it possible to send the data necessary to first display all details of the portion of the image that contains the visual attention center, followed by other parts of the image away from the visual attention center.

In general, progressive JPEG XL works in the following way: There is always an 8×8 downsampled image available (similar to a DC-only scan in a progressive JPEG). The decoder can display that with a nice upsampling, which gives the impression of a smoothed version of the image.

In addition, the image is divided into square groups (typically of size 256×256) and it is possible to provide an order of these groups during encoding. In particular, as illustrated in FIG. 3, example implementations of the present disclosure can order the groups based on the location of the predicted visual attention center.

For example, while the JPEG XL format allows for a very flexible order of the groups, example implementations of the present disclosure can choose as a starting group the group that includes the predicted visual attention center. The encoding system can then grow concentric squares around that starting group. To make successive updates even less noticeable, some implementations can smooth the boundary between groups for which all the data has arrived and those that still contain an incomplete approximation. JPEG XL is provided as one example of a progressive image loading format. Other formats can be used additionally or alternatively.

### Example Devices and Systems

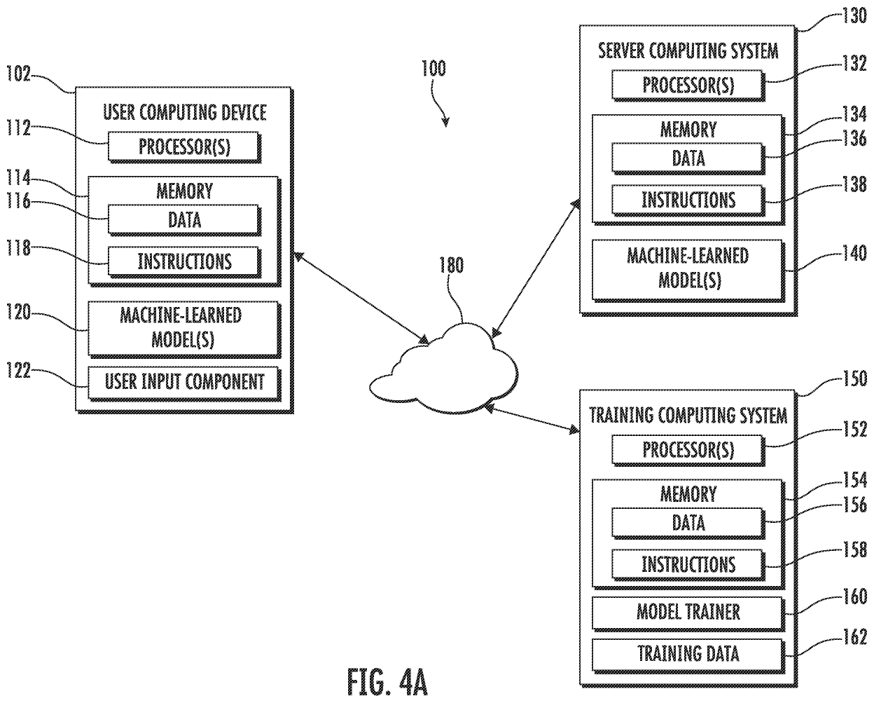

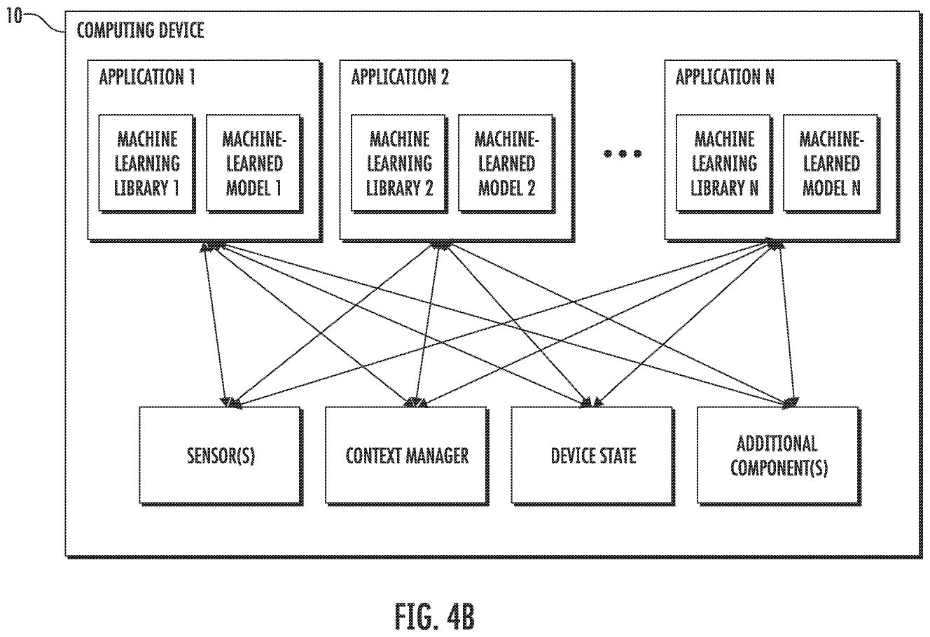

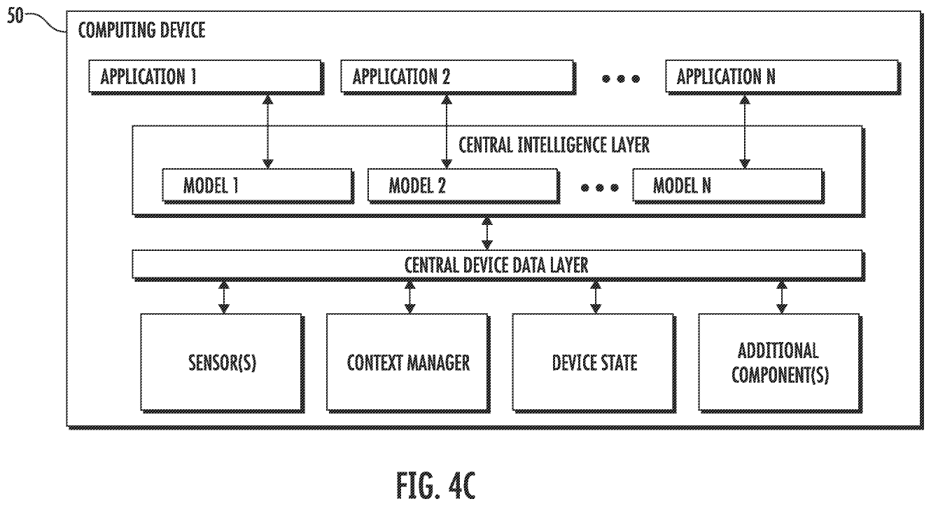

FIG. 4A depicts a block diagram of an example computing system 100 according to example embodiments of the present disclosure. The system 100 includes a user computing device 102, a server computing system 130, and a training computing system 150 that are communicatively coupled over a network 180.

The user computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 102 includes one or more processors 112 and a memory 114. The one or more processors 112 can be any suitable processing device (e.g., a processor core, a microprocessor, an ASIC, an FPGA, a controller, a microcontroller, etc.) and can be one processor or a plurality of processors that are operatively connected. The memory 114 can include one or more non-transitory computer-readable storage media, such as RAM, ROM, EEPROM, EPROM, flash memory devices, magnetic disks, etc., and combinations thereof. The memory 114 can store data 116 and instructions 118 which are executed by the processor 112 to cause the user computing device 102 to perform operations.

In some implementations, the user computing device 102 can store or include one or more visual attention center prediction models 120. For example, the visual attention center prediction models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models). Example visual attention center prediction models 120 are discussed with reference to FIGS. 1-3.

In some implementations, the one or more visual attention center prediction models 120 can be received from the server computing system 130 over network 180, stored in the user computing device memory 114, and then used or otherwise implemented by the one or more processors 112. In some implementations, the user computing device 102 can implement multiple parallel instances of a single visual attention center prediction model 120.

Additionally or alternatively, one or more visual attention center prediction models 140 can be included in or otherwise stored and implemented by the server computing system 130 that communicates with the user computing device 102 according to a client-server relationship. For example, the visual attention center prediction models 140 can be implemented by the server computing system 140 as a portion of a web service (e.g., an image encoding, transmission, and/or loading service). Thus, one or more models 120 can be stored and implemented at the user computing device 102 and/or one or more models 140 can be stored and implemented at the server computing system 130.

The user computing device 102 can also include one or more user input components 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 130 includes one or more processors 132 and a memory 134. The one or more processors 132 can be any suitable processing device (e.g., a processor core, a microprocessor, an ASIC, an FPGA, a controller, a microcontroller, etc.) and can be one processor or a plurality of processors that are operatively connected. The memory 134 can include one or more non-transitory computer-readable storage media, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more visual attention center prediction models 140. For example, the models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models). Example models 140 are discussed with reference to FIGS. 1-3.

The user computing device 102 and/or the server computing system 130 can train the models 120 and/or 140 via interaction with the training computing system 150 that is communicatively coupled over the network 180. The training computing system 150 can be separate from the server computing system 130 or can be a portion of the server computing system 130.

The training computing system 150 includes one or more processors 152 and a memory 154. The one or more processors 152 can be any suitable processing device (e.g., a processor core, a microprocessor, an ASIC, an FPGA, a controller, a microcontroller, etc.) and can be one processor or a plurality of processors that are operatively connected. The memory 154 can include one or more non-transitory computer-readable storage media, such as RAM, ROM, EEPROM, EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the machine-learned models 120 and/or 140 stored at the user computing device 102 and/or the server computing system 130 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 160 can perform a number of generalization techniques (e.g., weight decays, dropouts, etc.) to improve the generalization capability of the models being trained.

In particular, the model trainer 160 can train the visual attention center prediction models 120 and/or 140 based on a set of training data 162. In some implementations, if the user has provided consent, the training examples can be provided by the user computing device 102. Thus, in such implementations, the model 120 provided to the user computing device 102 can be trained by the training computing system 150 on user-specific data received from the user computing device 102. In some instances, this process can be referred to as personalizing the model.

The model trainer 160 includes computer logic utilized to provide desired functionality. The model trainer 160 can be implemented in hardware, firmware, and/or software controlling a general purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium such as RAM, hard disk, or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

Some or all of the devices illustrated in FIG. 4A can include an image encoder and/or decoder (e.g., a “codec”) for a progressive image loading format (e.g., JPEG XL).

FIG. 4A illustrates one example computing system that can be used to implement the present disclosure. Other computing systems can be used as well. For example, in some implementations, the user computing device 102 can include the model trainer 160 and the training dataset 162. In such implementations, the models 120 can be both trained and used locally at the user computing device 102. In some of such implementations, the user computing device 102 can implement the model trainer 160 to personalize the models 120 based on user-specific data.

FIG. 4B depicts a block diagram of an example computing device 10 that performs according to example embodiments of the present disclosure. The computing device 10 can be a user computing device or a server computing device.

The computing device 10 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 4B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 4C depicts a block diagram of an example computing device 50 that performs according to example embodiments of the present disclosure. The computing device 50 can be a user computing device or a server computing device.

The computing device 50 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 4C, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 4C, the central device data layer can communicate with a number of other components of the computing device, such as, for example, one or more sensors, a context manager, a device state component, and/or additional components. In some implementations, the central device data layer can communicate with each device component using an API (e.g., a private API).

### Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

1. A computer system for prediction of visual attention centers, the computer system comprising:
one or more processors;
a machine-learned visual attention center prediction model configured to receive and process an input image to predict a visual attention center for the input image; and
one or more non-transitory computer-readable media that collectively store instructions that, when executed by the one or more processors, cause the computer system to perform operations, the operations comprising:
obtaining the input image;
processing the input image with the machine-learned visual attention center prediction model to obtain the visual attention center for the input image; and
providing the visual attention center for the input image as an output.

2. The computer system of claim 1, wherein:
the input image comprises a plurality of pixels; and
the machine-learned visual attention center prediction model is configured to predict a single group of one or more pixels as the visual attention center for the input image.

3. The computer system of claim 1, wherein:
the input image comprises a plurality of pixels; and
the machine-learned visual attention center prediction model is configured to predict a single pixel as the visual attention center for the input image.

4. The computer system of claim 1, wherein the visual attention center predicted for the input image by the machine-learned visual attention center prediction model comprises a portion of the input image that is predicted to be at a center of human visual attention afforded to the input image over a period of viewing time.

5. The computer system of claim 1, wherein providing the visual attention center for the input image as the output comprises using the visual attention center to perform one or more of image compression, progressive image encoding, or progressive image decoding on the input image.

6. The computer system of claim 1, wherein providing the visual attention center for the input image as the output comprises:
ordering a plurality of subportions of the input image into an encoding or decoding order, wherein the encoding or decoding order is based at least in part on the visual attention center for the input image; and
encoding or decoding the input image according to a progressive image loading format and according to the encoding or decoding order.

7. The computer system of claim 1, wherein:
the machine-learned visual attention center prediction model has been trained on a set of training data;
the training data comprises a plurality of training examples; and
each training example comprises a training image and a label that indicates a labelled visual attention center for the training image.

8. The computer system of claim 7, wherein the labelled visual attention center for the training image for each training image has been generated by:
obtaining a plurality of attention points for the training image, the plurality of attention points indicating respective locations of human visual attention on the training image;
filtering the plurality of attention points to determine a filtered set of attention points; and
determining the labelled visual attention center based on the filtered set of attention points.

9. The computer system of claim 8, wherein filtering the plurality of attention points to determine the filtered set of attention points comprises one or both of:
performing temporal filtering to filter out any of the plurality of attention points that correspond to respective locations of human visual attention that occur after a threshold period of viewing time; and
performing spatial filtering to filter out any of the plurality of attention points that exist in a region of the training image having a attention point density below a threshold level of density.

10. A computer-implemented method for training a visual attention center prediction model, the method comprising:
obtaining, by a computing system comprising one or more computing devices, a set of training data, wherein the training data comprises a plurality of training examples, and wherein each training example comprises a training image and a label that indicates a labelled visual attention center for the training image;
accessing, by the computing system, the visual attention center prediction model, wherein the visual attention center prediction model is configured to receive and process an input image to predict a visual attention center for the input image; and
for each of the plurality of training examples:
processing, by the computing system, the training image with the visual attention center prediction model to obtain a predicted visual attention center for the training image;
evaluating, by the computing system, a loss function that compares the predicted visual attention center for the training image to the labelled visual attention center for the training image provided by the label; and
modifying, by the computing system, one or more parameters of the visual attention center prediction model based on the loss function.

11. The computer-implemented method of claim 10, wherein:
obtaining, by the computing system, the set of training data, comprises generating, by the computing system, the respective label for each training image; and
for each training image, generating, by the computing system, the respective label comprises:
obtaining, by the computing system, a plurality of attention points for the training image, the plurality of attention points indicating respective locations of human visual attention on the training image;
determining, by the computing system, the labelled visual attention center based on the plurality of attention points.

12. The computer-implemented method of claim 11, wherein determining, by the computing system, the labelled visual attention center based on the plurality of attention points comprises:
filtering, by the computing system, the plurality of attention points to determine a filtered set of attention points; and
determining, by the computing system, the labelled visual attention center based on the filtered set of attention points.

13. The computer-implemented method of claim 12, wherein filtering the plurality of attention points to determine the filtered set of attention points comprises:
performing, by the computing system, temporal filtering to filter out any of the plurality of attention points that correspond to respective locations of human visual attention that occur after a threshold period of viewing time.

14. The computer-implemented method of claim 12, wherein filtering the plurality of attention points to determine the filtered set of attention points comprises:
performing, by the computing system, spatial filtering to filter out any of the plurality of attention points that exist in a region of the training image having a attention point density below a threshold level of density.

15. The computer-implemented method of claim 12, wherein determining, by the computing system, the labelled visual attention center based on the filtered set of attention points comprises:
determining a center of the filtered set of attention points; and
setting the labelled visual attention center equal to the center of the filtered set of attention points.

16. The computer-implemented method of claim 10, wherein:
each training image comprises a plurality of pixels; and
the visual attention center prediction model is configured to predict a single group of one or more pixels as the predicted visual attention center for the training image.

17. The computer-implemented method of claim 10, wherein:
each training image comprises a plurality of pixels; and
the visual attention center prediction model is configured to predict a single pixel as the predicted visual attention center for the training image.

18. The computer-implemented method of claim 10, wherein the predicted visual attention center predicted for each training image by the visual attention center prediction model comprises a portion of the training image that is predicted to be at a center of human visual attention afforded to the training image over a period of viewing time.

19. One or more non-transitory computer-readable media that collectively store instructions, that when executed by one or more processors, cause the one or more processors to perform operations to encode an input image, the operations comprising:
obtaining the input image;
processing the input image with a machine-learned visual attention center prediction model to obtain a visual attention center predicted for the input image by the machine-learned visual attention center prediction model;
ordering a plurality of subportions of the input image into an encoding or decoding order, wherein the encoding or decoding order is based at least in part on the visual attention center predicted for the input image by the machine-learned visual attention center prediction model; and
encoding or decoding the input image according to a progressive image loading format and the encoding or decoding order.

20. The one or more non-transitory computer-readable media of claim 19, wherein the progressive image loading format comprises JPEG XL.
